(19) United States
(12) Patent Application Publication
(10) Pub. No.: US 2006/0123107 A1
(43) Pub. Date: Jun. 8, 2006

(54) Web link management systems and methods

(76) Inventor: Hung-Chi Chen, Miaoli Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/001,765

(22) Filed: Dec. 2, 2004

(51) Int. Cl. G06F 15/16; G06F 15/173

(52) U.S. Cl. 709/224; 709/219

(57) ABSTRACT

Systems and methods for Web link management. A storage device stores a status record comprising link status information indicating whether a Web link is available. A processing unit periodically issues a Web page request to a Web server corresponding to the Web link, receives a Web page response from the Web server, and updates the status record according to the Web page response.

### BACKGROUND

The invention relates to website management technology, and more particularly, to systems and methods of web link management.

The Internet provides a mechanism by which users, using computers or other information access devices, can obtain large amounts of information about a wide variety of subjects from a large number of websites. Generally, information provided by websites is in the form of Web pages, generally in HTML (HyperText mark-up language) format, a text-based format that dictates how the respective Web page is to be displayed by a computer, and provides textual information, typically in ASCII form, and graphical information generally in a compressed format such as “GIF” or “JPEG.” In addition, a Web page will typically have hypertext links to other Web pages which may be provided by the same site as the original Web page, as well as other Web pages which may be provided by other websites.

A hyperlink is a connection between an element in a Web page such as a word, phrase, symbol, or image, and another Web page. If a hyperlink is clicked and an error page or exception page is shown to indicate the linked object is unavailable, unnecessary time is spent. In view of the limitation, a need exists for systems and methods of web link management, thereby preventing to connect to an unavailable page.

### SUMMARY

Systems for Web link management are provided. An exemplary embodiment comprises a storage device storing a status record and a processing unit. The status record comprises link status information indicating whether a Web link is available. The processing unit couples to the storage device, periodically issues a Web page request to a Web server corresponding to the stored Web link, receives a Web page response from the Web server, and updates the status record according to the Web page response. The processing unit updates the status record to indicate the Web link is unavailable when the Web page response comprises an error message, or updates the status record to indicate the Web link is available when the Web page response comprises the linked object. The processing unit may also receive a Web page request for a Web page comprising the Web link from a client computer, acquire a link status for the Web link by querying the status record, and transmit the Web page comprising the Web link and the link status thereof to the client computer.

Another exemplary embodiment comprises a processing unit. The processing unit receives a Web page request for a Web page comprising a Web link from a client computer, acquires a link status for the Web link by querying a remote computer, and transmits the Web page comprising the Web link and the link status thereof to the client computer. The link status may be represented by a graph. The link status for the Web link may be acquired by issuing a remote procedure call (RPC), or executing a CORBA object method or a Web service operation in the remote computer.

Web link management methods are further provided. An exemplary method periodically issues a Web page request to a Web server corresponding to a Web link, receives a Web page response from the Web server, and updates the status record accordingly. The status record stores link status information indicating whether the Web link is available.

Some embodiments of a method for Web link management may further update the status record to indicate the Web link is unavailable when the Web page response comprises an error message, and otherwise, update the status record to indicate the Web link is available when the Web page response comprises the linked object. The method may further receive a Web page request for a Web page comprising the Web link from a client computer, acquire a link status for the Web link by querying the status record, and transmit the Web page comprising the Web link and the link status thereof to the client computer. The method may further receive a Web page request for a Web page comprising the Web link from a client computer, acquire a link status for the Web link by querying the status record, and transmit the Web page comprising the Web link and a graph representing the link status thereof to the client computer.

The Web page request may constitute hypertext transfer protocol (HTTP), and the Web page response may constitute HTTP. The Web page may be encoded in hypertext markup language (HTML).

### BRIEF DESCRIPTION OF THE DRAWINGS

Web link management systems and methods will become apparent by referring to the following detailed description of embodiments with reference to the accompanying drawings, wherein:

FIG. 1 is a diagram of an embodiment of Web link management system;

FIG. 2 is a diagram of a hardware environment applicable to computers in an embodiment of Web link management system;

FIG. 3 is a flowchart showing an embodiment of a method of Web link management for modification of status records;

FIG. 4 is a diagram of a storage medium storing a computer program providing an embodiment of a method of Web link management for modification of status records;

FIG. 5 is a flowchart showing an embodiment of a method of Web link management for Web page generation;

FIGS. 6a, 6b and 6c are screen diagrams depicting exemplary Web pages in different aspects;

FIG. 7 is a diagram of a storage medium storing a computer program providing an embodiment of a method of Web link management for Web page generation.

### DESCRIPTION

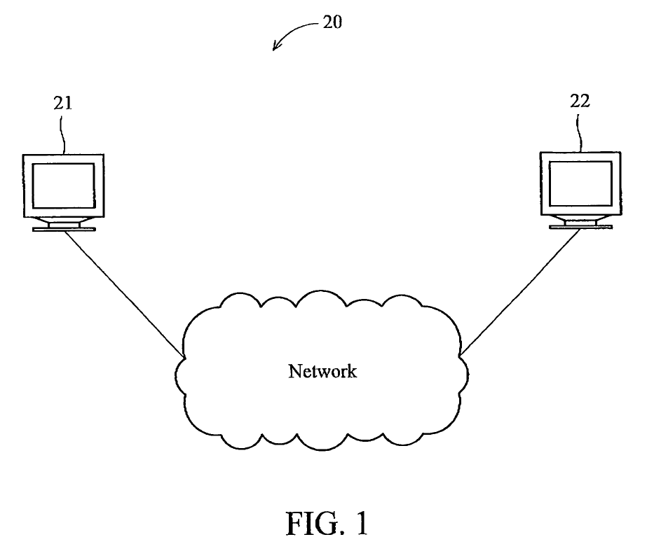

FIG. 1 is a diagram of an embodiment of Web link management system 20, comprising computers 21 and 22, operating in a network (preferably Internet or Intranet)using logical connections to each other. Those skilled in the art will recognize that the computers 21 and 22 may be connected in different types of networking environments, and communicate between different types of networking environments through various types of transmission devices such as routers, gateways, access points, base station systems or others.

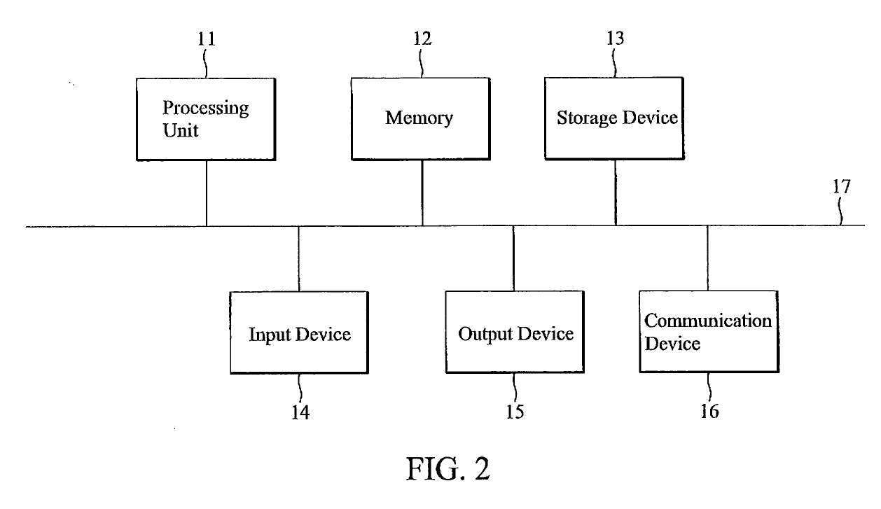

FIG. 2 is a diagram of a hardware environment applicable to computers in an embodiment of Web link management system. The description of FIG. 2 provides a brief, general description of suitable computer hardware and a suitable computing environment for computers 21 and 22 in conjunction with which at least some embodiments of the invention may be implemented. The hardware environment of FIG. 2 includes a processing unit 11, a memory 12, a storage device 13, an input device 14, an output device 15 and a communication device 16. The processing unit 11 is connected by buses 17 to the memory 12, storage device 13, input device 14, output device 15 and communication device 16 based on von Neumann architecture. There may be one or more processing units 11, such that the processor of the computer comprises a single central processing unit (CPU), a micro processing unit (MPU) or multiple processing units, commonly referred to as a parallel processing environment. The memory 12 is preferably a random access memory (RAM), but may also include read-only memory (ROM) or flash ROM. The memory 12 preferably stores program modules executed by the processing unit 11 to perform Web link management functions. Generally, program modules include routines, programs, objects, components, scripts, Web pages, or others, that perform particular tasks or implement particular abstract data types. Moreover, those skilled in the art will understand that some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web objects, Web Services or other similar architectures. The storage device 13 may be a hard drive, magnetic drive, optical drive, portable drive, or nonvolatile memory drive. The drives and associated computer-readable media thereof (if required) provide nonvolatile storage of computer-readable instructions, data structures and program modules. The processing unit 11, controlled by program modules received from the memory 12 and from an operator through the input device, directs Web link management functions.

The computer 21 comprises a Web server executed by the processing unit 11 therein. The Web server comprises several Web pages responsive to hypertext transfer protocol (HTTP) requests. Generally, information provided by the Web server is in the form of Web pages, generally in HTML (HyperText mark-up language) format, which is a text-based format that describes how the respective Web page is to be displayed by a computer, and provides textual information, typically in ASCII form, and graphical information generally in a compressed format such as “GIF” or “JPEG.” Such HTML documents may include scripts (e.g., JavaScript, Visual Basic Scripts, Active Server Page Scripts and the like) providing Web link management functionality.

The computer 22 stores multiple status records in its storage device 13. Each status record indicates whether a specific hyperlink is available or unavailable, and preferably includes two fields, link address and link status. Consistent with the scope and spirit of the invention, additional or different contents may be provided in the status records. The implementation of the status records described above is not limited to a single table, file or data object, but also to multiple related tables, files or data objects in a database management system, a file system or an object base system. The computer 22 preferably provides a remote object, such as DCOM, CORBA, Web service and the like, providing the function of status record acquisition, enabling the computer 21 to acquire link status for different link addresses by issuing a remote procedure call (RPC), executing a CORBA object method or a Web service operation.

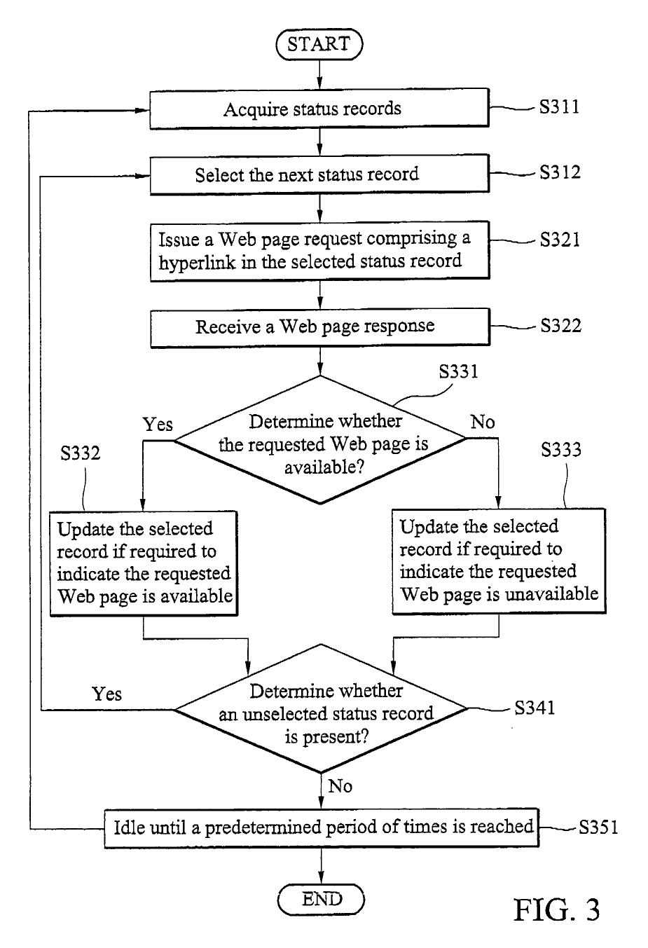

An embodiment of the Web link management method is disclosed to periodically update status records, employed by the computer 22. FIG. 3 is a flowchart showing an embodiment of a method of Web link management for modification of status records. In step S311, all status records are acquired. The status records may be acquired by executing at least one ANSI SQL query, data object method, file manipulation instruction, or others, and be stored in a recordset or dataset in the memory 12. In step S312, the next status record is selected. In step S321, a Web page request, preferably a HTTP request, comprising a link address in the selected status record is issued to a destination computer via the communication device 16. In step S322, a Web page response, preferably a HTTP response, is received from the destination computer via the communication device 16. In step S331, it is determined whether the requested Web page is available, and, if so, the process proceeds to the step S332, and otherwise, to the step S333. For example, if the received Web page response is a regular Web page, the requested Web page is available, and otherwise, if the received Web page response notes an error, such as “HTTP 404 error”, the requested Web page is unavailable. In step S332, the selected record is updated, if required, to indicate the requested Web page is available. In step 5333, the selected record is updated, if required, to indicate the requested Web page is unavailable. In step S341, it is determined whether an unselected status record is present in the recordset or dataset, and, if so, the process proceeds to step S312, and otherwise, to step S351. In step S351, the process remains idle until a predetermined period of time is reached. The predetermined period of time, for example, thirty minutes, 1 hour, or others, may be configured by an operator.

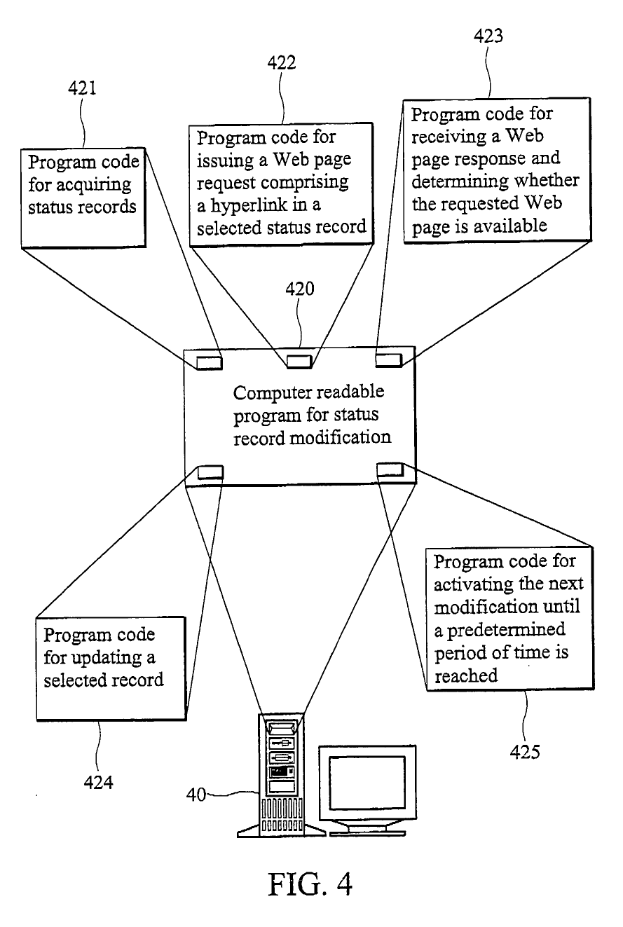

Also disclosed is a storage medium as shown in FIG. 4 storing a computer program 420 providing the disclosed method of Web link management to periodically update status records. The computer program product includes a storage medium 40 having computer readable program code embodied in the medium for use in a computer system. The computer readable program code comprises at least computer readable program code 421 acquiring status records, computer readable program code 422 issuing a Web page request comprising a hyperlink in a selected status record, computer readable program code 423 receiving a Web page response and determining whether the requested Web page is available, computer readable program code 424 updating a selected record, and computer readable program code 425 activating the next modification until a predetermined period of time is reached.

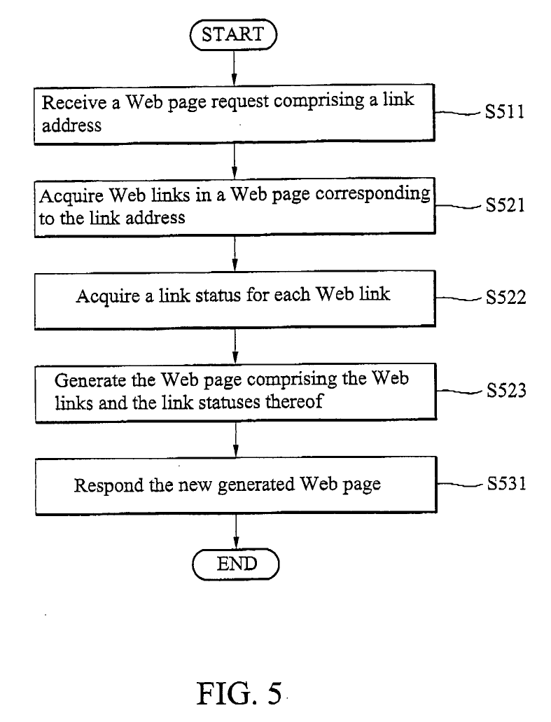

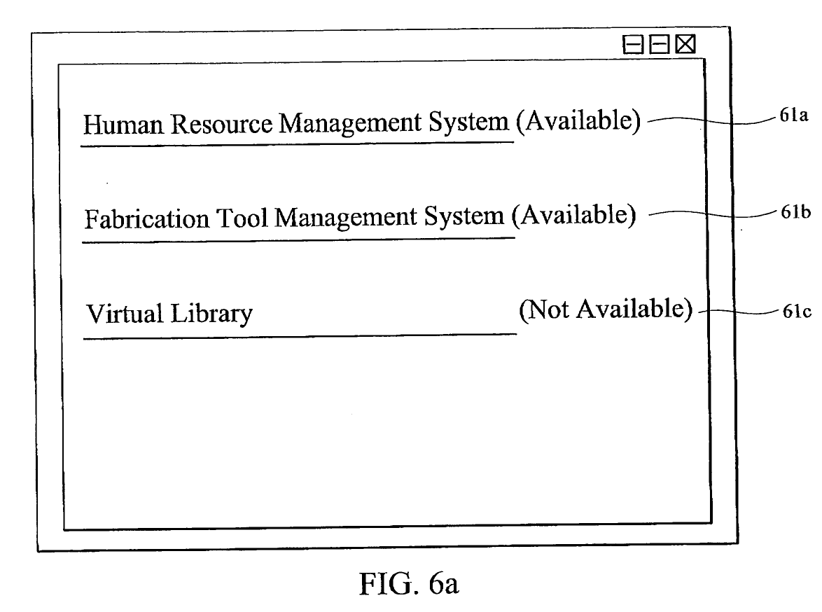

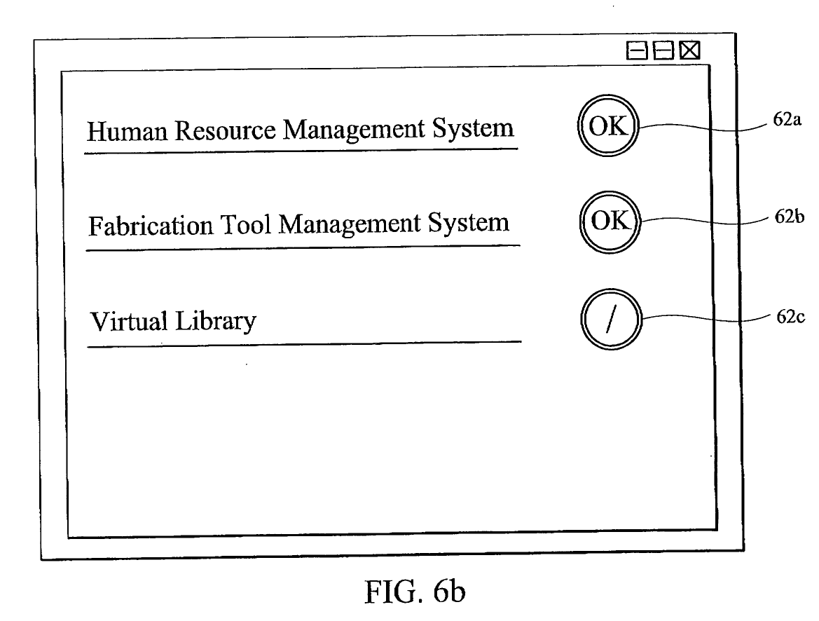

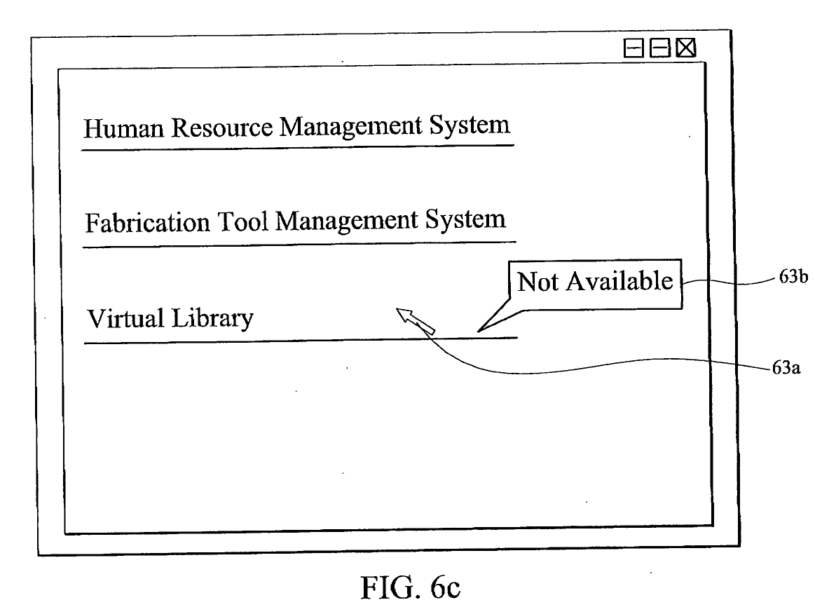

An embodiment of the Web link management method is disclosed to generate a Web page, employed by the computer 21 in combination with a Web server. FIG. 5 is a flowchart showing an embodiment of a method of Web link management for Web page generation. In step S511, a Web page request, preferably a HTTP request, comprising a link address is received via the communication device 16 from a client computer (not shown). In step S521, Web links in a Web page corresponding to the link address are acquired. In one example, the information regarding that a Web page comprises specific Web links corresponding to the link address is stored in at least one table, file or data object in a database system, a file system or an object base system, and the Web links may be acquired by executing at least one ANSI SQL query, data object method, file manipulation instruction, or others. In another example, the information regarding that a Web page comprises specific Web links may be acquired by directly parsing source code of Web page corresponding to the link address. In step S522, link status for each Web link is acquired from the computer 22. The link status may be acquired by issuing a remote procedure call (RPC) to the computer 22, executing a CORBA object method or a Web service operation provided by the computer 22. In step S523, a Web page corresponding to the link address and comprising the Web links and the link status thereof is generated. Various approaches can be utilized to represent link status. FIG. 6a, 6b and 6c are diagrams showing exemplary Web pages. Referring to FIG. 6a, in one example, link status is displayed in text strings 61a, 61b and 61c. Referring to FIG. 6b, in another example, link status is represented by graphs 62a, 62b and 62c. Referring to FIG. 6c, in yet another example, link status may be appeared in a bubble window 63b when a pointer 63a moving to a Web like is detected. Generation of Web page for various representations of link status is well-known in the art, and is described briefly herein. In step S531, a Web page response, preferably a HTTP response, comprising the new generated Web page, is transmitted to the client computer (not shown).

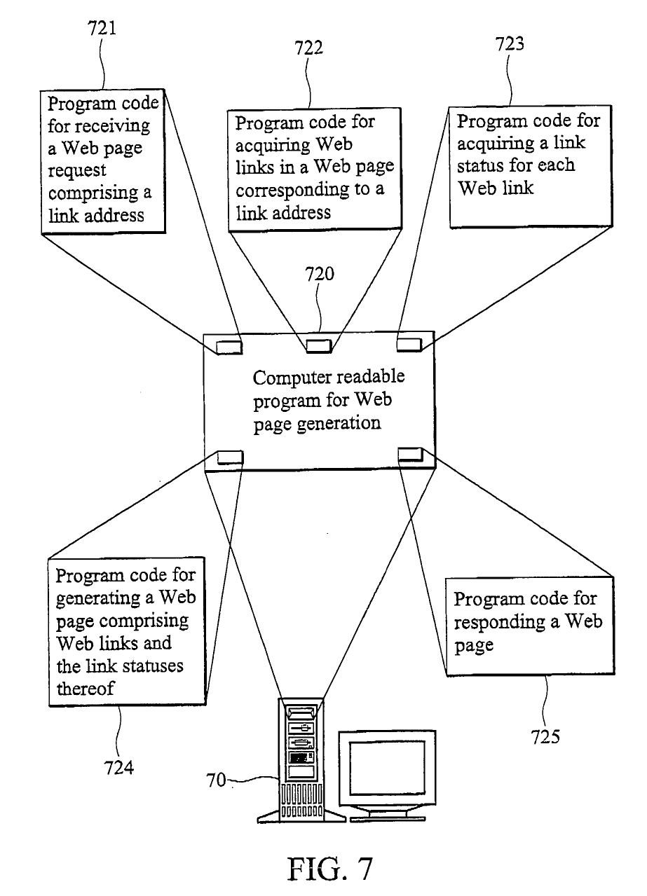

Also disclosed is a storage medium as shown in FIG. 7 storing a computer program 720 providing the disclosed method of Web link management to generate Web pages. The computer program product includes a storage medium 70 having computer readable program code embodied in the medium for use in a computer system. The computer readable program code comprises at least computer readable program code 721 receiving a Web page request comprising a link address, computer readable program code 722 acquiring Web links in a Web page corresponding to a link address, computer readable program code 723 acquiring link status for each Web link, computer readable program code 724 generating a Web page comprising Web links and link status thereof, and computer readable program code 725 generating and responding a Web page.

Although embodiments of the invention have been described applied in two computers, this is not intended to limit the invention. Those who are skilled in this technology can apply the disclosed embodiments to a single computer for status record modification and Web page generation.

Web link management systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not intended to limit the invention thereto. Those skilled in this technology can make various alterations and modifications without departing from the scope and spirit of the invention. Therefore, the scope of the invention shall be defined and protected by the following claims and their equivalents.

What is claimed is:

1. A system for Web link management, comprising:
a storage device storing a status record comprising link status information indicating whether a Web link is available;
a processing unit coupled to the storage device, periodically issuing a Web page request to a Web server corresponding to the Web link, receiving a Web page response from the Web server, and updating the status record according to the Web page response.

2. The system of claim 1 wherein the Web page request is HyperText Transfer Protocol (HTTP) request, and the Web page response is HTTP response.

3. The system of claim 1 wherein the processing unit updates the status record to indicate the Web link is unavailable when the Web page response comprises an error message.

4. The system of claim 1 wherein the processing unit updates the status record to indicate the Web link is available when the Web page response comprises a Web page.

5. The system of claim 4 wherein the Web page is encoded in HyperText Markup Language (HTML).

6. The system of claim 1 wherein the processing unit further receives a Web page request for a Web page comprising the Web link from a client computer, acquires link status for the Web link by querying the status record, and transmits the Web page comprising the Web link and the link status thereof to the client computer.

7. The system of claim 6 wherein the Web page is encoded in HyperText Markup Language (HTML).

8. The system of claim 1 wherein the processing unit receives a Web page request for the Web page comprising the Web link from a client computer, acquires link status for the Web link by querying the status record, and transmits the Web page comprising the Web link and a graph representing the link status thereof to the client computer.

9. A method of Web link management, comprising using a computer to perform the steps of:
periodically issuing a Web page request to a Web server corresponding to a Web link;
receiving a Web page response from the Web server; and
updating the status record according to the Web page response, the status record storing link status information indicating whether the Web link is available.

10. The method of claim 9 wherein the Web page request is HyperText Transfer Protocol (HTTP) request, and the Web page response is HTTP response.

11. The method of claim 9 wherein the step of updating further comprises updating the status record to indicate the Web link is unavailable when the Web page response comprises an error message.

12. The method of claim 9 wherein the step of updating further comprises updating the status record to indicate the Web link is available when the Web page response comprises a Web page.

13. The method of claim 12 wherein the Web page is encoded in HyperText Markup Language (HTML).

14. The method of claim 9, further comprising:
receiving a Web page request for a Web page comprising the Web link from a client computer;
acquiring link status for the Web link by querying the status record; and
e . transmitting the Web page comprising the Web link and the link status thereof to the client computer.

15. The method of claim 14 wherein the Web page is encoded in HyperText Markup Language (HTML).

16. The method of claim 9, further comprising:
receiving a Web page request for a Web page comprising the Web link from a client computer;
acquiring link status for the Web link by querying the status record; and
transmitting the Web page comprising the Web link and a graph representing the link status thereof to the client computer.

17. A system for Web link management, comprising:
a processing unit receiving a Web page request for a Web page comprising a Web link from a client computer, acquiring link status for the Web link by querying a remote computer, and transmitting the Web page comprising the Web link and the link status thereof to the client computer.

18. The system of claim 17 wherein the Web page encoded in HyperText Markup Language (HTML).

19. The system of claim 17 wherein the link status is represented by a graph.

20. The system of claim 17 wherein the link status for the Web link is acquired by issuing a remote procedure call (RPC), or executing a CORBA object method or Web service operation in the remote computer.
